(19) United States
(12) Patent Application Publication
(10) Pub. No.: US 2021/0245248 A1
(43) Pub. Date: Aug. 12, 2021

(54) METHOD FOR PRODUCING THREE-DIMENSIONAL MOLDED OBJECT

(71) Applicant: Sodick Co., Ltd., Yokohama (JP)

(72) Inventors: Ichiro ARAIE, Yokohama (JP); Kazufumi NAMBU, Kyoto city (JP)

(73) Assignee: Sodick Co., Ltd., Yokohama (JP)

(21) Appl. No.: 17/242,946

(22) Filed: Apr. 28, 2021

Related U.S. Application Data
(63) Continuation-in-part of application No. 15/841,833, filed on Dec. 14, 2017.

(30) Foreign Application Priority Data
Jan. 24, 2017 (JP) 2017-010581
Nov. 8, 2017 (JP) 2017- 215496

(51) Int. Cl. B22F 10/64; B22F 10/66; B22F 10/28; B22F 12/41; B33Y 10/00; B33Y 70/00

(52) U.S. Cl. CPC B22F 10/64; B22F 10/66; B22F 10/28; B22F 12/41; B22F 2301/15; B33Y 70/00; B22F 2301/35; B22F 2302/40; B33Y 10/00

(57) ABSTRACT

According to a several embodiment, provided is a method for manufacturing a molded object, including a material preparing step to prepare a material powder obtained by removing carbon from medium carbon steel or high carbon steel until a carbon content is 0.1 mass % or less, a molding step to form a desired molded object by a lamination molding method repeating the steps of: a recoating step to uniformly spread the material powder on a molding table to form a material powder layer; and a sintering step to irradiate a predetermined portion of the material powder layer with a laser beam to form a sintered layer; and a carburization step to subject the molded object to carburization after the molding step is performed.

This is a continuation in part of U.S. patent application No. 15/841,833, filed on Dec. 14, 2017, which claims priority to Japanese application No. 2017-010581, filed Jan. 24, 2017, and Japanese application No. 2017-215496, filed Nov. 8, 2017, the entire contents of which are incorporated herein by reference.

### BACKGROUND OF THE INVENTION

### Field of the Invention

The present invention relates to a method for manufacturing a three-dimentional molded object.

### BACKGROUND OF THE INVENTION

In a powder sintering lamination molding method using a laser beam, an extremely thin material powder layer is formed on a molding table movable in a vertical direction, the molding table being placed in a sealed chamber filled with inert gas. Subsequently, predetermined portions of this material powder layer are irradiated with the laser beam to sinter the material powder at the position of irradiation, thereby forming a sintered layer. These procedures are repeated to form a desired three-dimensional shape composed of a sintered body integrally formed by laminating a plurality of sintered layers. In particular, regarding a lamination molding apparatus equipped with a cutting device, by using a rotary cutting tool such as an end mill, surface of the sintered body and the unnecessary portion obtained by sintering the material powder can be subject to cutting, thereby allowing to form a highly accurate molded object. These procedures are combined and repeated to form a desired laminated molded object. Here, when the material powder is an iron-based metal powder material, a certain amount or more of carbon is added to provide desired strength (see, Patent Literature 1).

### PRIOR ART DOCUMENTS

### Patent Literature

[Patent Literature 1] JP 3997123B

### SUMMARY OF INVENTION

### Technical Problem

However, in a case where lamination molding is performed using a metal material powder containing carbon by a certain amount or more, the molded object may expand due to martensitic transformation after molding, and thus the desired dimensional accuracy may not be obtained. That is, the molded object immediately after molding is austenitized due to heating by the laser beam, and is transformed into the martensitic state by cooling. The crystal structure changes from a face-centered cubic lattice structure (FCC) to a body-centered tetragonal structure (BCT), thereby being increased in volume. It is known that the amount of expansion tends to increase as the amount of carbon in the material powder increases. Here, it takes from several hours to several days for the martensitic transformation to complete and the dimension to settle, depending on the environmental temperature. Therefore, even when machining is performed with high precision using the cutting device during molding, the dimension would change after molding, thereby being unable to obtain the desired dimension. In addition, such change may cause crack in the molded object.

The present invention has been made by taking these circumstances into consideration. An object of the present invention is to provide a method for manufacturing a molded object, the change in the dimension of the molded object after molding being small, and the molded object having required hardness. In addition, the present invention provides a method for manufacturing a molded object showing sufficient elongation to suppress crack due to the change in dimension after molding, and the molded object also having required hardness.

### Means to Solve the Problem

According to several embodiments of the present invention, a method for manufacturing a molded object, comprising:

a material preparing step to prepare a material powder obtained by removing carbon from medium carbon steel or high carbon steel until a carbon content is 0.1 mass % or less,

a molding step to form a desired molded object by a lamination molding method repeating the steps of:
a recoating step to uniformly spread the material powder on a molding table to form a material powder layer; and

a sintering step to irradiate a predetermined portion of the material powder layer with a laser beam to form a sintered layer; and

a carburization step to subject the molded object to carburization after the molding step is performed, is provided.

### Effect of the Invention

In the manufacturing method of the present invention, a material powder with relatively small carbon content is used as the material powder in lamination molding to form the molded object, and then the molded object is subject to carburization. In particular, the material used as the material powder is obtained by removing carbon from the medium carbon steel or the high carbon steel until the carbon content is 0.1 mass % or less. According to such process, change in the dimension of the molded object due to the martensitic transformation can be suppressed, and the required hardness can be achieved.

Hereinafter, various embodiments of the present invention will be provided. The embodiments provided below can be combined with each other.

Preferably, the carbon content of the material powder is 0.05 mass % or less.

Preferably, the carbon content of the material powder is 0.03 mass % or less.

Preferably, the material powder made of a material is composed of: 0.1 mass % or less carbon, 1.00 mass % or less silicon, 1.00 mass % or less manganese, 0.040 mass % or less phosphorus, 0.015 mass % or less sulfur, 12.00 mass % or more and 14.00 mass % or less chromium, 0.60 mass % or less nickel, and a balance being iron and inevitable impurities.

Preferably, the material powder made of a material is composed of: 0.1 mass % or less carbon, 0.80 mass % or more and 1.20 mass % or less silicon, 0.50 mass % or less manganese, 0.030 mass % or less phosphorus, 0.030 mass % or less sulfur, 4.50 mass % or more and 5.50 mass % or less chromium, 1.00 mass % or more and 1.50 mass % or less molybdenum, 0.80 mass % or more and 1.20 mass % or less vanadium, and a balance being iron and inevitable impurities.

Preferably, the molded object after the carburization step has an elongation by 3.4% or less.

Preferably, the molded object before the carburization step has a surface hardness by Rockwell hardness HRC of 34 or less.

Preferably, the molded object after the carburization step has a surface hardness by Rockwell hardness HRC of 50 or more.

Preferably, the lamination molding method further repeats a cutting step to perform cutting to the sintered layer during the molding step.

### BRIEF DESCRIPTION OF THE DRAWINGS

The above further objects, features and advantages of the present invention will become more apparent from the following detailed description taken in conjunction with the accompanying drawings, wherein:

FIG. 1 is a rough structural diagram of a lamination molding apparatus according to an embodiment of the present invention.

FIG. 2 is a perspective view of a powder layer forming apparatus 3 and a laser beam emitter 13 according to an embodiment of the present invention.

FIG. 3 is a perspective view of a recoater head 11 according to an embodiment of the present invention.

FIG. 4 is a perspective view of the recoater head 11 according to an embodiment of the present invention, observed from another angle.

FIG. 5 is an explanatory drawing of a lamination molding method using the lamination molding apparatus according to an embodiment of the present invention.

FIG. 6 is an explanatory drawing of a lamination molding method using the lamination molding apparatus according to an embodiment of the present invention.

FIG. 7 is an explanatory drawing of a lamination molding method using the lamination molding apparatus according to an embodiment of the present invention.

FIG. 8 is a picture of test piece A prepared by lamination molding in the Examples and Comparative Examples.

FIG. 9 is a picture of test piece B prepared by lamination molding in the Examples and Comparative Examples.

### DESCRIPTION OF THE PREFERRED EMBODIMENTS

Hereinafter, the embodiments of the present invention will be described with reference to the drawings. Here, the characteristic matters shown in the embodiments can be combined with each other.

The method for manufacturing a molded object according to the first embodiment of the present invention comprises a molding step and a carburization step. Hereinafter, each of the steps shall be explained in detail.

(1) molding step

In the molding step, a recoating step to form a material powder layer 8 by uniformly spreading a material powder on a molding table 5, and a sintering step to form a sintered layer by irradiating a predetermined portion of the material powder 8 with a laser beam L are repeated to form the desired molded object. Namely, the molding step is a step to form the desired molded object by a lamination molding method repeating the recoating step and the sintering step. The lamination molding method may include a cutting step to perform cutting to the sintered layer. Hereinafter, the lamination molding apparatus which can be used to perform these steps shall be explained in detail.

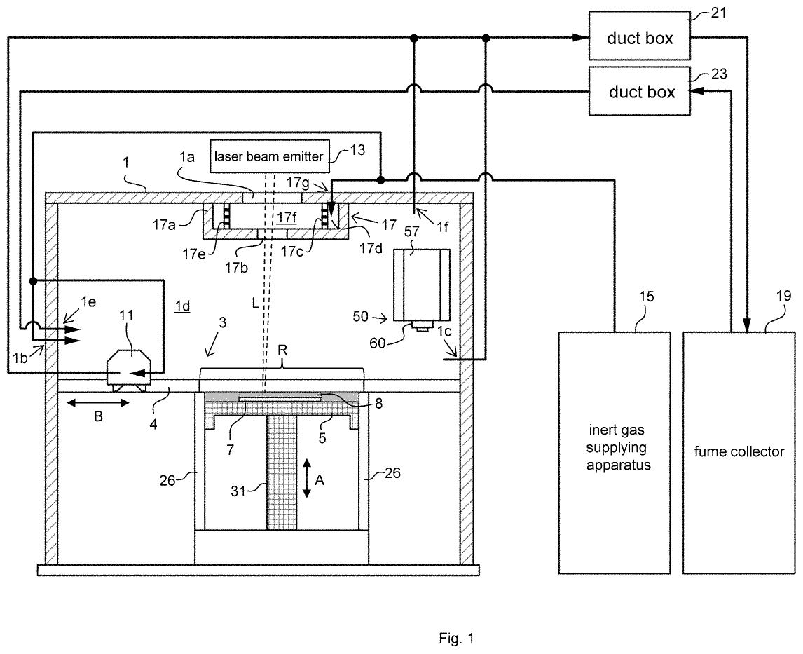

As shown in FIG. 1, the lamination molding apparatus according to an embodiment of the present invention comprises a chamber 1 and a laser beam emitter 13.

The chamber 1 covers a desired molding region R and is filled with an inert gas having a desired concentration. In the chamber 1, a powder layer forming apparatus 3 is provided, and a protection window contamination prevention device 17 is provided at the upper surface. The powder layer forming apparatus 3 comprises a base table 4 and a recoater head 11.

The base table 4 comprises a molding region R in which the laminated molded object is formed. In the molding region R, a molding table 5 is provided. The molding table 5 can be moved in a vertical direction (shown by arrow A in FIG. 1) by a molding table driving mechanism 31. When the lamination molding apparatus is used, a molding plate 7 is placed on the molding table 5, and the material powder layer 8 is formed on the molding plate 7. Here, a predetermined irradiation region is within the molding region R, and approximately matches the region surrounded by the contour shape of the desired three-dimensional molded object.

A powder retaining wall 26 is provided so as to surround the molding table 5. Non-sintered material powder is retained in a powder retaining space surrounded by the powder retaining wall 26 and the molding table 5. Although not shown in FIG. 1, in the lower side of the powder retaining wall 26, a powder discharging section capable of discharging the material powder in the powder retaining space can be provided. In such case, after completion of the lamination molding, the molding table 5 is descended so as to discharge the non-sintered material powder from the powder discharging section. The material powder discharged is guided to a chute by a chute guide, and then the material powder is retained in a bucket via the chute.

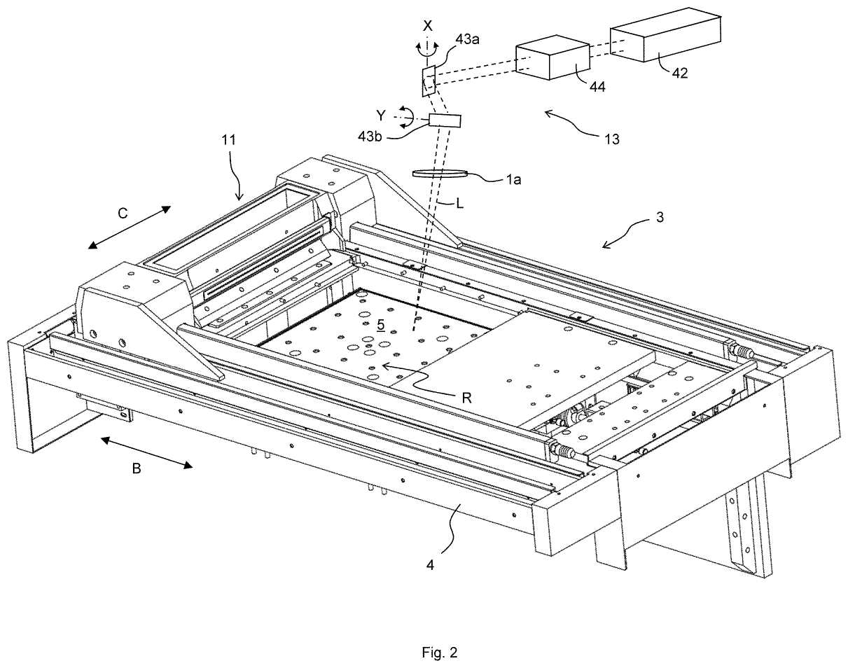

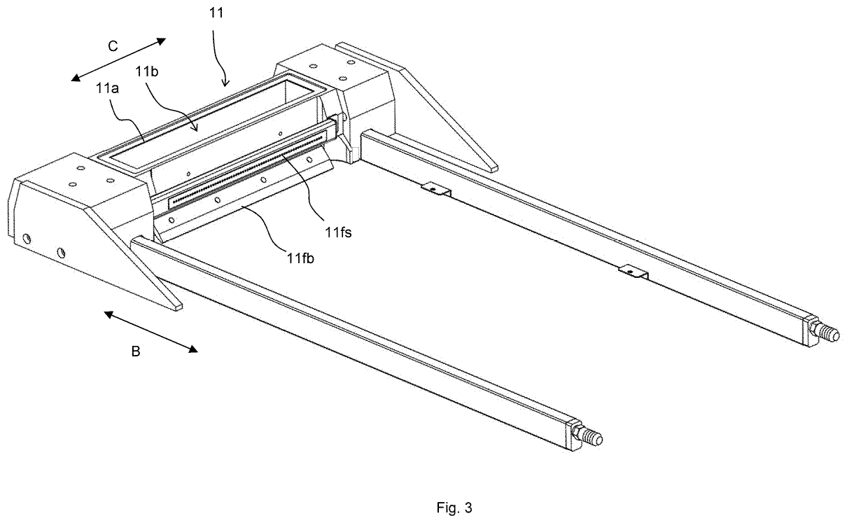

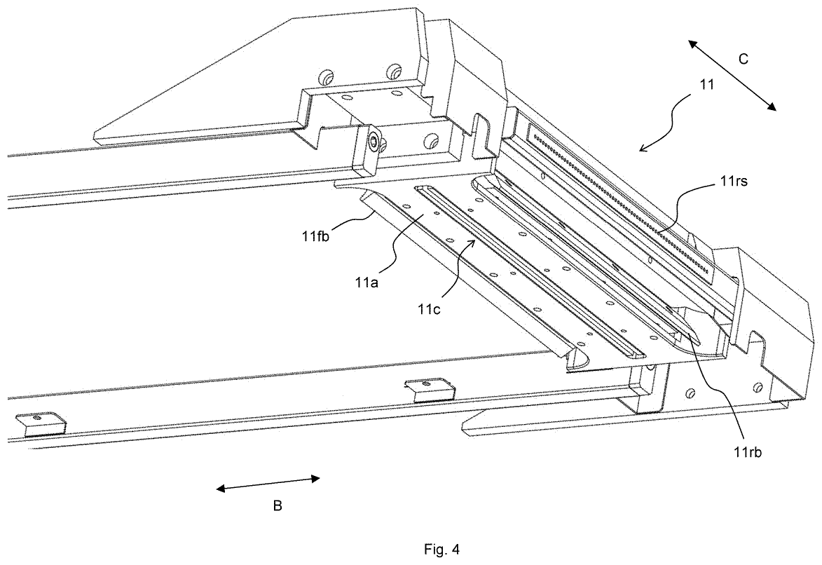

As shown in FIGS. 2 to 4, the recoater head 11 comprises a material holding section 11a , a material supplying section 11b, and a material discharging section 11c.

The material holding section 11a stores the material powder. The material supplying section 11b is provided on the top surface of the material holding section 11a, and receives the material powder supplied from a material supplying device (not shown) to the material holding section 11a. The material discharging section 11c is provided on the bottom surface of the material holding section 11a, and discharges the material powder in the material holding section 11a. Here, the material discharging section 11c has a slit shape which elongates in the horizontal uniaxial direction (direction shown by arrow C) crossing orthogonally with the moving direction (direction shown by arrow B) of the recoater head 11.

Here, the material powder is made of steel. Steel may contain aluminum, boron, cobalt, chromium, copper, lanthanum, molybdenum, niobium, nickel, lead, cerium, tellurium, vanadium, tungsten, zirconium, silicon, manganese, phosphorus and the like as additive elements. Further, the shape of the material powder is a sphere with an average particle diameter of 20 μm. A plurality of different metal material powder can be combined and used as the material powder.

From the viewpoint of suppressing martensitic transformation after molding, it is preferable that the carbon content of the material powder be low. In addition, from the viewpoint of providing sufficient elongation in order to suppress crack due to the change in the dimension after molding, it is also preferable that the carbon content of the material powder be low. If the cutting step is performed, the from the viewpoint of facilitating the cutting by reducing the hardness of the sintered layer during molding, it is preferable that the carbon content of the material powder be low. On other hand, the molded object requires the sufficient hardness. The higher the carbon content of the material powder is, the higher the hardness of the molded object is.

There is the material powder for lamination molding made of medium carbon steel or high carbon steel. The medium carbon steel is steel having a carbon content of 0.25 mass % or more and less than 0.6 mass %. The high carbon steel is steel having a carbon content of 0.6 mass % or more. When lamination molding is performed using the medium carbon steel or the high carbon steel, the sufficient hardness is obtained, but problems caused by carbon written above may occur.

Therefore, in the embodiment, lamination molding is performed using the material powder made of the material obtained by removing carbon from the conventional medium carbon steel or the conventional high carbon steel, and the carburization step is performed to the molded object after lamination molding. Consequently, the change in the dimension and the crack are suppressed, and cutting during molding is facilitated. It is possible to obtain the molded object having the hardness equivalent to the molded object made of the medium carbon steel or the high carbon steel. The carbon content of the material powder after removing carbon is 0.1 mass % or less, preferably 0.05 mass % or less, and more preferably 0.03 mass % or less. In other words, the method for manufacturing the molded object in the embodiment includes material preparing step to prepare the material powder obtained by removing carbon from the medium carbon steel or the high carbon steel until the carbon content is 0.1 mass % or less.

In the embodiment, for example, the material obtained by removing carbon from SUS420J2 until the carbon content is 0.1 mass % or less (referred to as C-less SUS420J2 hereafter) or the material obtained by removing carbon from SKD61 until the carbon content is 0.1 mass % or less (referred to as C-less SKD61 hereafter) is preferably used. SUS420J2 is the medium carbon steel, and martensitic stainless steel. SUS420J2 for lamination molding is composed of 0.26 mass % or more and 0.50 mass % or less carbon, 1.00 mass % or less silicon, 1.00 mass % or less manganese, 0.040 mass % or less phosphorus, 0.015 mass % or less sulfur, 12.00 mass % or more and 14.00 mass % or less chromium, 0.60 mass % or less nickel, and the balance being iron and inevitable impurities. C-less SUS420J2 has an equivalent composition as SUS420J2 except that the carbon content is 0.1 mass % or less, preferably 0.05 mass % or less, and more preferably 0.03 mass % or less. SKD61 is the medium carbon steel, and alloy tool steel. SKD61 for lamination molding is composed of 0.32 mass % or more and 0.52 mass % or less carbon, 0.80 mass % or more and 1.20 mass % or less silicon, 0.50 mass % or less manganese, 0.030 mass % or less phosphorus, 0.030 mass % or less sulfur, 4.50 mass % or more and 5.50 mass % or less chromium, 1.00 mass % or more and 1.50 mass % or less molybdenum, 0.80 mass % or more and 1.20 mass % or less vanadium, and the balance being iron and inevitable impurities. C-less SKD61 has an equivalent composition as SDK61 except that the carbon content is 0.1 mass % or less, preferably 0.05 mass % or less, and more preferably 0.03 mass % or less.

A blade 11fband a recoater head supplying opening 11fs are provided on one side of the recoater head 11, and a blade 11rb and a recoater head discharging opening 11rs are provided on the other side of the recoater head 11. The blades 11fb and 11rb spread the material powder. In other words, the blades 11fb and 11rb form the material powder layer 8 by planarizing the material powder discharged from the material discharging section 11c. The recoater head supplying opening 11fs and the recoater head discharging opening 11rs are provided along the horizontal uniaxial direction (direction shown by arrow C) crossing orthogonally with the moving direction (direction shown by arrow B) of the recoater head 11, thereby supplying and discharging the inert gas, respectively (details to be described later). Here, in the present specification, “inert gas” is a gas which substantially does not react with the material powder, and nitrogen gas, argon gas, and helium gas can be mentioned for example.

A cutting machine 50 has a machining head 57 provided with a spindle head 60. The machining head 57 moves the spindle head 60 to a desired position in a horizontal direction and a vertical direction, where such movement is controlled by a machining head driving mechanism (not shown).

The spindle head 60 is configured to rotate with a cutting tool such as an end mill or the like (not shown) being attached, and thus cutting can be applied to the surface or unnecessary portions of the sintered layer obtained by sintering the material powder. Further, the cutting tool preferably comprises a plurality of kinds of cutting tools, and the cutting tool to be used can be changed by an automatic tool changer (not shown) during the molding step.

On the upper surface of the chamber 1, a protection window contamination prevention device 17 is provided so as to cover the protection window 1a. The protection window contamination prevention device 17 is provided with a cylindrical housing 17a and a cylindrical diffusing member 17c arranged in the housing 17a. An inert gas supplying space 17d is provided in between the housing 17a and the diffusing member 17c. Further, on the bottom surface of the housing 17a, an opening 17b is provided at the inner portion of the diffusing member 17c. The diffusing member 17c is provided with a plurality of pores 17e, and a clean inert gas supplied into the inert gas supplying space 17d is filled into a clean room 17f through the pores 17e. Then, the clean inert gas filled in the clean room 17f is discharged towards below the protection window contamination prevention device 17 through the opening 17b.

A laser beam emitter 13 is provided above the chamber 1. The laser beam emitter 13 emits the laser beam L towards a predetermined portion of the material powder layer 8 formed on the molding region R so as to sinter the material powder at the irradiation position. Specifically, the laser beam emitter 13 comprises a laser beam source 42, two-axis galvanometer mirrors 43a and 43b, and a focus control unit 44. Each of the galvanometer mirrors 43a and 43b includes an actuator, each of the actuators rotating each of the galvanometer mirrors 43a and 43b, respectively.

The laser beam source 42 emits the laser beam L. Here, the laser beam L is a laser capable of sintering the material powder, for example, a CO₂ laser, fiber laser, YAG laser and the like.

The focus control unit 44 focuses the laser beam L output from the laser beam source 42 and adjusts the diameter of the laser beam to a desired spot diameter. The two-axis galvanometer mirrors 43a and 43b are controlled so as to perform two-dimensional scanning with the laser beam L emitted from the laser beam source 42. The galvanometer mirror 43a scans the laser beam L in the X-axis direction, and the galvanometer mirror 43b scans the laser beam L in the Y-axis direction. Each of the galvanometer mirrors 43a and 43b is controlled of its rotation angle depending on the size of the rotation angle controlling signal input from a control device (not shown). Accordingly, the laser beam L can be emitted to a desired position by altering the size of the rotation angle controlling signal being input to each of the actuators of the galvanometer mirrors 43a and 43b.

The laser beam L which passed through the galvanometer mirrors 43a and 43b further passes through the protection window 1a provided to the chamber 1. Then, the material powder layer 8 formed in the molding region R is irradiated with the laser beam L. The protection window 1a is formed with a material capable of transmitting the laser beam L. For example, in a case where the laser beam L is fiber laser or YAG laser, the protection window 1a can be structured with a quartz glass.

Next, an inert gas supplying/discharging system will be explained. The inert gas supplying/discharging system comprises a plurality of supplying openings and discharging openings of the inert gas provided in the chamber 1, and pipes for connecting each supplying opening and discharging opening to an inert gas supplying apparatus 15 and fume collector 19. In the present embodiment, the supplying openings including a recoater head supplying opening 11fs, a chamber supplying opening 1b, a sub supplying opening 1e and a protection window contamination prevention device supplying opening 17g, and the discharging openings including a chamber discharging opening 1c, a recoater head discharging opening 11rs and a sub discharging opening 1f are provided.

The recoater head supplying opening 11fs is provided so as to correspond with the installation position of the chamber discharging opening 1c and to face the chamber discharging opening 1c. Preferably, the recoater head supplying opening 11fs is provided on one side of the recoater head 11 along the direction indicated as the arrow C so as to face the chamber discharging opening 1c when the recoater head 11 is positioned on the opposite side across the predetermined irradiation region with respect to a position at which the material supplying device (not shown) is installed.

The chamber discharging opening 1c is provided on the side wall of the chamber 1 at a certain distance from the predetermined irradiation region so as to face the recoater head supplying opening 11fs. A suction device (not shown) may be provided connecting with the chamber discharging opening 1c. The suction device facilitates eliminating the fume efficiently from the optical path of the laser beam L. In addition, the suction device enables a greater amount of fume to be discharged through the chamber discharging opening 1c, thereby the fume diffusion within the molding room 1d is suppressed.

The chamber supplying opening 1b is provided at the edge of the base table 4 so as to face the chamber discharging opening 1c across a predetermined irradiation region. The chamber supplying opening 1b is selectively switched to open and the recoater head supplying opening 11fs is switched to close, when the recoater head 11 passes the predetermined irradiation region and the recoater head supplying opening llfs is placed directly facing the chamber discharging opening 1c without the spacing of the predetermined irradiation region. Accordingly, since the chamber supplying opening 1b supplies the inert gas into the chamber discharging opening 1c, the pressure and flow rate of the inert gas being supplied into the chamber discharging opening 1c being the same as the inert gas supplied from the recoater head supplying opening llfs, a flow of the inert gas in the same direction is constantly generated. Consequently, stable sintering is beneficially provided.

The recoater head discharging opening 11rs is provided on the recoater head 11 along the direction shown by arrow C, at the opposite side of the side in which the recoater head supplying opening 11fs is provided. When the recoater head supplying opening 11fs does not supply the inert gas, in other words, when the chamber supplying opening 1b supplies the inert gas, some fume is discharged by generating a flow of inert gas in the more vicinity of the predetermined irradiation region, thereby eliminating the fume more efficiently from the optical path of the laser beam L.

The inert gas supplying/discharging system according to the present embodiment comprises a sub supplying opening 1e, a protection window contamination prevention device supplying opening 17g, and a sub discharging opening 1f. The sub supplying opening 1e is provided on the side wall of the chamber 1 so as to face the chamber discharging opening 1c, and supplies from the fume collector 19 to the molding room 1d clean inert gas removed of fume. The protection window contamination prevention device supplying opening 17g is provided on the upper surface of the chamber 1 to supply inert gas to the protection window contamination prevention device 17. The sub discharging opening 1f is provided at the upper side of the chamber discharging opening 1c to discharge inert gas containing a large amount of fume remaining at the upper side of the chamber 1.

The inert gas supplying system to supply the inert gas into the chamber 1 is connected with the inert gas supplying apparatus 15 and fume collector 19. The inert gas supplying apparatus 15 has a function to supply the inert gas, and is, for example, a device comprising a membrane type nitrogen separator to extract the nitrogen gas from the circumambient air. In the present embodiment, as shown in FIG. 1, the inert gas supplying apparatus 15 is connected to the recoater head supplying opening 11fs, chamber supplying opening 1b and protection window contamination prevention device supplying opening 17g.

The fume collector 19 comprises duct boxes 21 and 23 provided at its upper stream side and its lower stream side, respectively. The inert gas containing fume discharged from the chamber 1 through the chamber discharging opening 1c and sub discharging opening 1f is sent to the fume collector 19 through the duct box 21. Then, fume is removed in the fume collector 19, and the cleaned inert gas is sent to the sub supplying opening 1e of the chamber 1 through the duct box 23. According to such constitution, the inert gas can be recycled.

As for the fume discharging system as shown in FIG. 1, the chamber discharging opening 1c, recoater head discharging opening 11rs and sub discharging opening 1f are connected with the fume collector 19 through the duct box 21. The inert gas after removal of the fume by the fume collector 19 is sent to the chamber 1 and is recycled.

(lamination molding method)

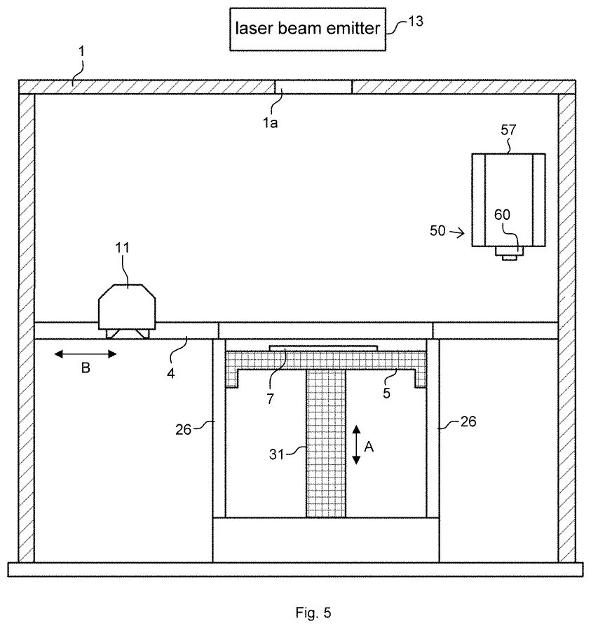

Subsequently, referring to FIGS. 1 and to 5 to 7, the lamination molding method using the afore-mentioned lamination molding apparatus will be explained. Here, in FIGS. 5 to 7, some of elements shown in FIG. 1 are omitted, taking visibility into consideration.

First, the molding plate 7 is placed on the molding table 5, and the height of the molding table 5 is adjusted to an appropriate position (FIG. 5). In this state, the recoater head 11 with the material holding section 11a being filled with the material powder is moved from the left side to the right side of the molding region R, in the direction shown by arrow B in FIG. 5. Accordingly, a first layer of the material powder layer 8 is formed on the molding plate 7.

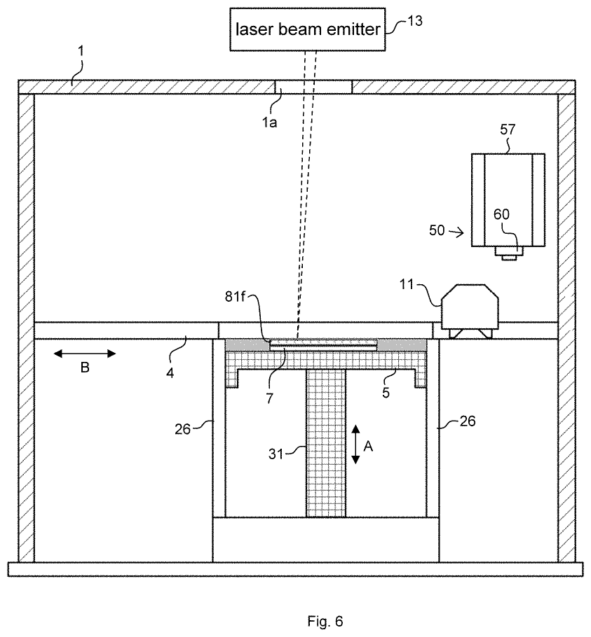

Subsequently, predetermined portion of the material powder layer 8 is irradiated with the laser beam L, thereby sintering the portion of the material powder layer 8 being irradiated with the laser beam L. Accordingly, the first layer of sintered layer 81f being a divided layer having a predetermined thickness with respect to the entire laminated molded object is obtained as shown in FIG. 6.

Then, the height of the molding table 5 is descended by the predetermined thickness (one layer) of the material powder layer 8. Subsequently, the recoater head 11 is moved from the right side to the left side of the molding region R. Accordingly, a second layer of the material powder layer 8 is formed on the sintered layer 81f.

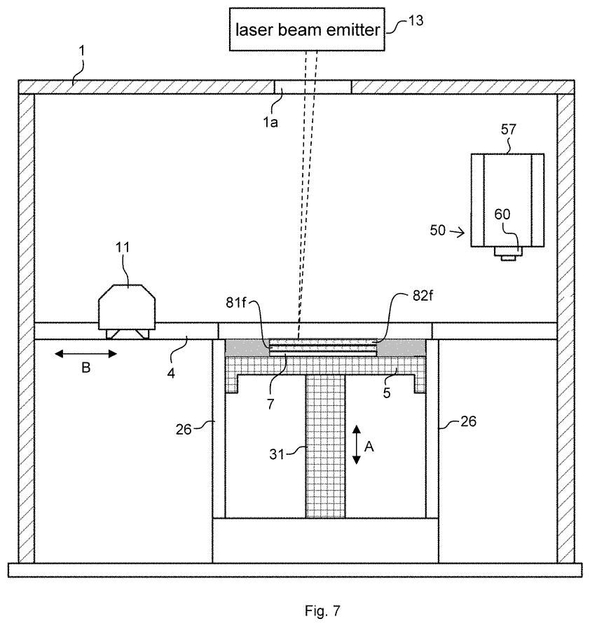

Next, predetermined portion of the material powder layer 8 is irradiated with the laser beam L, thereby sintering the portion of the material powder layer 8 being irradiated with the laser beam. Accordingly, the second layer of sintered layer 82f is obtained as shown in FIG. 7.

By repeating these procedures, the third and subsequent layers of sintered layers are formed. The adjacent sintered layers are firmly fixed with each other.

Here, in the lamination molding apparatus provided with a cutting device 50 as in the present embodiment, the cutting step can be performed to cut end faces of the sintered layers every time after forming a predetermined number of sintered layers, in which cutting is performed using a rotational cutting tool attached to the spindle head 60. That is, the lamination molding method in the embodiment may repeat the recoating step, the sintering step, and the cutting step. Further, when a sputtering generated during sintering adheres onto the surface of the sintered layer, a protruded abnormal sintered portion may be formed. Cutting can be performed to the top surface of the sintered layer to remove the abnormal sintered portion when the recoater head clashes. In a case where the lamination molding is performed using a material powder with low carbon content, martensitic transformation hardly occur, that is, quenching by the heat of the laser beam L hardly occur. Accordingly, hardness of the sintered layer is relatively low. Therefore, when a sintered layer formed with a material powder with low carbon content is subject to cutting, load is hardly applied to the rotational cutting tool, thereby elongating the lifetime of the rotational cutting tool.

As described, a recoating step to uniformly spread a material powder on a molding table 5, thereby forming a material powder layer 8, and a sintering step to form a sintered layer by irradiating a predetermined portion of the material powder layer 8 with laser beam L are repeated to obtain the molded object having a desired three-dimensional shape composed of a sintered body integrally formed by laminating a plurality of sintered layers.

(2) carburization step

In the carburization step, the molded object obtained by lamination molding using a material powder is subjected to carburization. Such treatment allows improvement in hardness at the surface and at the vicinity of the surface of the molded object compared with the molded object before carburization.

In the molding step, carbon content of the material powder used need be kept low in order to suppress or prevent change in shape due to martensitic transformation of the molded object. Therefore, carbon content would be set to an amount lower than the content which is predicted to provide the desired hardness to the molded object. Accordingly, the hardness of the molded object obtained by the molding step alone is not sufficient. However, by performing carburization, carbon content at the surface and at the vicinity of the surface of the molded object can be increased. That is, the molded object having desired hardness can be manufactured. Here, the molded object after the carburization step preferably has a surface hardness by Rockwell hardness HRC of 50 or more.

Here, there is no particular limitation regarding the treating method for carburization, so long as the carbon content at the surface and at the vicinity of the surface of the molded object can be increased. For example, carburization can be performed by methods such as pack carburization, gas carburization, liquid carburization, vacuum carburization, plasma carburization.

Although embodiments of the present invention and modifications thereof have been described, they have been presented as examples and are not intended to limit the scope of the invention. These novel embodiments can be implemented in various other forms, and various omissions, substitutions, and changes can be made without departing from the spirit of the invention. These embodiments and modifications thereof are included in the scope and gist of the invention and are included in the invention described in the claims and the equivalent scope thereof.

### EXAMPLES

Hereinafter, the present invention shall be explained with reference to the embodiments, however, the present invention shall not be limited to these embodiments.

Material powder with an average particle diameter of 20 μm with varied carbon content was used. Examples and Comparative Examples were molded, subject to carburization, and evaluated. In Examples 1 and 2, the material powder for molding was C-less SUS420J2. In Comparative Example 1, the material powder for molding was SUS420J2.

### Example 1

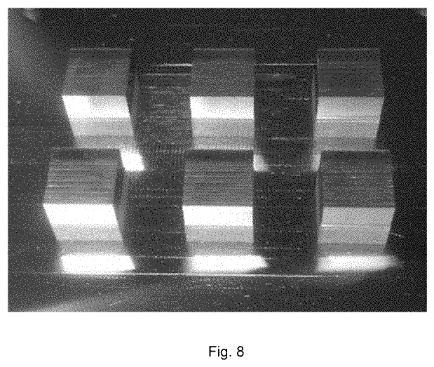

Material powder with carbon content of 0.025 mass % was used, and 6 cube molded objects in the size of 20 mm ×20 mm ×20 mm (length ×width ×height) were formed with a predetermined spacing on a molding plate by lamination molding, thereby obtaining test pieces A as shown in FIG. 8. Here, temperature of the molding table was set to 120° C. The afore-mentioned cutting process was applied to the side surface of test pieces A by 10 mm from the upper surface, which were subject to dimension measurement. In addition, the test data for the test pieces A shown below are the average of the data obtained for the 6 test pieces A.

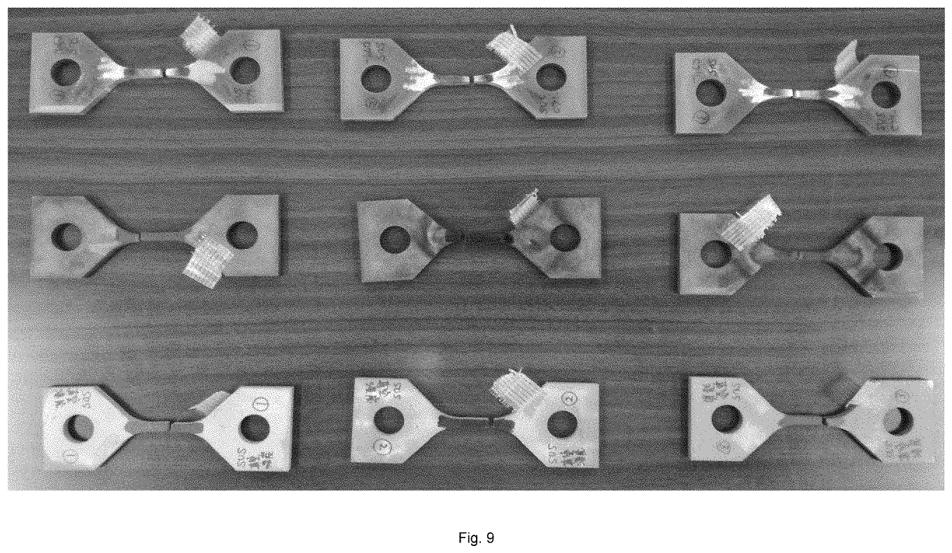

Further, by lamination molding using the same material, dumbbell-shaped molded object was formed on the molding plate. After molding, the molding plate and the molded object were separated using a wire electric discharge machine, thereby obtaining test pieces B as shown in FIG. 9. Test pieces B are 14B test pieces which are in compliance with Japanese Industrial Standards (JIS Z 2241). Here, temperature of the molding table was set to 120° C.

After 24 hours from modeling, test pieces A and test pieces B were subject to carburization to obtain carburized materials. Carburization was carried out by gas carburization with the following conditions. Here, carbon content of test pieces A before carburization and after carburization were measured under conditions where the test pieces A were cooled to room temperature (approximately 24° C.), using an EPMA: Electron Probe Micro Analyzer (JXA-8100 available from JEOL Ltd).
Carburization Conditions
Carburization method: gas carburization
Atmospheric gas: methane gas
Carburization temperature: 860 ° C.
Treatment time: 2 hours

### (Change in Dimension)

The dimensional change of the test piece A before the carburizing was evaluated by comparing the dimension of the piece A treatment at about 120° C. immediately after molding, and the dimension after 24 hours from cooling to room temperature (about 24° C.) after molding. Measurement was carried out with a touch sensor (KSH-E 25 PMP-100 available from Big Daishowa Seiki Co., Ltd.) on the lamination molding apparatus. In Example 1, the dimension changed by approximately −17 μm, thereby resulting in dimensional change of approximately 0.085%. This is 9.1×10⁻⁶ when converted into a thermal expansion coefficient, which is a value at a normal temperature change.

### (Hardness)

Rockwell hardness of the test piece A before carburization and after carburization were measured. Measurement was carried out in a condition where test piece A was cooled to room temperature (approximately 24° C.). Measurement was carried out using a micro Vickers hardness tester (HM-220D available from Mitutoyo Corporation). Results are shown in Table 1.

### (Elongation)

Elongation of the test piece B before carburization and after carburization were measured. Measurement was carried out in a condition where the test piece B was cooled to room temperature (approximately 24° C.). Measurement was carried out using a precision universal testing machine (AG-250 kNXplus available from Shimadzu Corporation). Results are shown in Table 1.

### Example 2

Treatment was carried out in the same manner as in Example 1 except that the carburization was carried out by vacuum carburizing according to the following conditions. The dimensional change was the same as in Example 1. The carbon content and each of the evaluation results is shown in Table 1.

### Carburization Conditions

Carburization method: vacuum carburization
Carburization temperature: 1030° C.
Treatment time: 1 hours

### Comparative Example 1

With respect to the lamination molding of the test piece A and the test piece B, the same procedure as in Example 1 was carried out except that a carbon material having a carbon content of 0.44 mass % was used and carburization was not carried out.

In Comparative Example 1, the dimension changed by approximately 135 μm, and the dimensional change was approximately 0.67%.

TABLE 1

| | Measured | | | Comparative |
|---|---|---|---|---|
| Table 1 | Object | Example 1 | Example 2 | Example 1 |
| Material | | C-less | C-less | SUS420J2 |
| | | SUS420J2 | SUS420J2 | |
| Before | | | | |
| Carburization | | | | |
| Carbon Content | Test Piece A | 0.025 | 0.025 | 0.44 |
| Before | | | | |
| Carburization | | | | |
| (mass %) | | | | |
| Hardness (HRC) | Test Piece A | 32-34 | 32-34 | 57-59 |
| Elongation (%) | Test Piece B | 18-27 | 18-27 | not |
| | | | | measureable |
| Dimension | Test Piece A | −0.085 | −0.085 | 0.67 |
| Change (%) | | | | |
| Carburization | Test Piece A | Gas | Vacuum | — |
| Method | | Carburiza- | Carburiza- | |
| | | tion | tion | |
| After | | | | |
| Carburization | | | | |
| Carbon Content | Test Piece A | 1 | not | — |
| After | | | measured | |
| Carburization | | | | |
| (mass %) | | | | |
| Hardness (HRC) | Test Piece A | 54-57 | 54-57 | — |
| Elongation (%) | Test Piece B | 2 | 3.2-3.4 | — |

As described above, in the comparative example where a material with carbon content of 0.44 mass % was used, the hardness of the molded object was sufficiently high, however, the dimensional change was large and thus not suitable for precise molding. In addition, since elongation was so small as to an unmeasurable degree, possibility of cracks due to dimensional change was high.

On the other hand, in Example 1 and Example 2 where materials with carbon content of 0.025 mass % were used, the dimensional change was small. Further, since elongation was sufficient, possibility of cracks due to dimensional change was low. Further, although hardness before carburization was low, sufficient hardness was obtained by carburization.

### EXPLANATION OF SYMBOLS

1: chamber
1a: protection window
1b: chamber supplying opening
1c: chamber discharging opening
1d: molding space
1e: sub supplying opening
1f: sub discharging opening
3: powder layer forming apparatus
4:base table
5:molding table
7:molding plate
8:material powder layer
11:recoater head
11a: material holding section
11b: material supplying section
11c: material discharging section
11fb: blade
11fs: recoater head supplying opening
11rb: blade
11rs: recoater head discharging opening
13: laser beam emitter
15: inert gas supplying apparatus
17: protection window contamination prevention device
17a: housing
17b: opening
17c: diffusing member
17d: inert gas supplying space
17e: pore
17f: clean room
17g: protection window contamination prevention device supplying opening
19: fume collector
21: duct box
23: duct box
26: powder retaining wall
31: molding table driving mechanism
42: laser beam source
43a: galvanometer mirror
43b: galvanometer mirror
44: focus control unit
50: cutting device
57: machining head
60: spindle head
81: sintered layer
82f: sintered layer
A: arrow
B: arrow
C: arrow
L: laser beam
R: molding region

Although various exemplary embodiments have been shown and described, the invention is not limited to the embodiments shown. Therefore, the scope of the invention is intended to be limited solely by the scope of the claims that follow.

What is claimed is:

1. A method for manufacturing a molded object, comprising:
a material preparing step to prepare a material powder obtained by removing carbon from medium carbon steel or high carbon steel until a carbon content is 0.1 mass % or less,
a molding step to form a desired molded object by a lamination molding method repeating the steps of:
a recoating step to uniformly spread the material powder on a molding table to form a material powder layer; and
a sintering step to irradiate a predetermined portion of the material powder layer with a laser beam to form a sintered layer; and
a carburization step to subject the molded object to carburization after the molding step is performed.

2. The method for manufacturing the molded object of claim 1, wherein the carbon content of the material powder is 0.05 mass % or less.

3. The method for manufacturing the molded object of claim 2, wherein the carbon content of the material powder is 0.03 mass % or less.

4. The method for manufacturing the molded object of claim 1, wherein the material powder made of a material is composed of:
0.1 mass % or less carbon,
1.00 mass % or less silicon,
1.00 mass % or less manganese,
0.040 mass % or less phosphorus,
0.015 mass % or less sulfur,
12.00 mass % or more and 14.00 mass % or less chromium,
0. 60 mass % or less nickel, and
a balance being iron and inevitable impurities.

5. The method for manufacturing the molded object of claim 1, wherein the material powder made of a material is composed of:
0.1 mass % or less carbon,
0.80 mass % or more and 1.20 mass % or less silicon,
0.50 mass % or less manganese,
0.030 mass % or less phosphorus,
0.030 mass % or less sulfur,
4.50 mass % or more and 5.50 mass % or less chromium,
1.00 mass % or more and 1.50 mass % or less molybdenum,
0.80 mass % or more and 1.20 mass % or less vanadium, and
a balance being iron and inevitable impurities.

6. The method for manufacturing the molded object of claim 1, wherein the molded object before the carburization step has an elongation by 18% or more.

7. The method for manufacturing the molded object of claim 1, wherein the molded object after the carburization step has an elongation by 3.4% or less.

8. The method for manufacturing the molded object of claim 1, wherein the molded object before the carburization step has a surface hardness by Rockwell hardness HRC of 34 or less.

9. The method for manufacturing the molded object of claim 1, wherein the molded object after the carburization step has a surface hardness by Rockwell hardness HRC of 50 or more.

10. The method for manufacturing the molded object of claim 1, wherein the lamination molding method further repeats a cutting step to perform cutting to the sintered layer during the molding step.
